(19) United States
(12) Patent Application Publication
(10) Pub. No.: US 2021/0357766 A1
(43) Pub. Date: Nov. 18, 2021

(54) CLASSIFICATION OF MAINTENANCE REPORTS FOR MODULAR INDUSTRIAL EQUIPMENT FROM FREE-TEXT DESCRIPTIONS

(71) Applicants: ABHISHEK PAUL, MELBOURNE, FL (US); CHRISTOPHER LOCK, HAUPPAUGE, NY (US)

(72) Inventors: ABHISHEK PAUL, MELBOURNE, FL (US); CHRISTOPHER LOCK, HAUPPAUGE, NY (US)

(73) Assignee: NORTHROP GRUMMAN SYSTEMS CORPORATION, FALLS CHURCH, VA (US)

(21) Appl. No.: 16/876,885

(22) Filed: May 18, 2020

(51) Int. Cl. G06N 5/02; G06K 9/62; G06Q 10/00; G06N 20/00

(52) U.S. Cl. CPC G06N 5/02; G06K 9/6278; G06N 20/00; G06K 9/6269; G06Q 10/20

(57) ABSTRACT

Systems and methods are provided for evaluating a maintenance report. A maintenance report is received for an item of modular industrial equipment. The maintenance report includes a maintenance-related code, selected from a defined library of maintenance-related codes, and a free text field describing either or both of an observation of the item of modular equipment that is inconsistent with a defined specification and an action taken to repair or maintain the item of modular industrial equipment. A plurality of features representing the semantic content of a free-text field are extracted, with at least a portion of the plurality of features being extracted via a document embedding approach. At an expert system, a new maintenance-related code is determined from the defined library of maintenance-related codes for the item of modular industrial equipment, from the plurality of features.

### TECHNICAL FIELD

This invention relates to electronic medical records systems, and more particularly, to classification of maintenance reports for modular industrial equipment from free-text descriptions.

### BACKGROUND

A maintenance form is a document that is used to keep maintenance record of items of equipment. Information on a maintenance form can include a maintenance date and time, a location, a maintenance purpose, a nature of the maintenance, a brief description of the maintenance, details of the nature and repair of breakage, a replacement of spare parts, any major complaint and its resolution, suggestions for improvement and development for the repaired parts, extra remarks from maintenance engineer, a signature and report submission from the maintenance engineer. The maintenance of many items of modular industrial equipment can be tracked by some form of maintenance form.

One class of modular industrial equipment for which maintenance forms are used includes military and commercial vehicles. For example, for military aircraft, a maintenance report referred to as a Maintenance Action Form (MAF) is used to report the a maintenance action taken for a military vehicle, such as a category of the action and a free text description of the action taken in a aircraft. The category of the action is used for a number of purposes after the report is submitted and is generally verified manually by analysts. In 2018, for one type of aircraft, analysts spent over 10,200 labor man hours for adjudications of the appropriate categories for MAF's, and this is expected to increase as more planes are produced.

### SUMMARY

In one example, a method is provided for evaluating a maintenance report. A maintenance report is received for an item of modular industrial equipment. The maintenance report includes a maintenance-related code, selected from a defined library of maintenance-related codes, and a free text field describing either or both of an observation of the item of modular equipment that is inconsistent with a defined specification and an action taken to repair or maintain the item of modular industrial equipment. A plurality of features representing the semantic content of a free-text field are extracted, with at least a portion of the plurality of features being extracted via a document embedding approach. At an expert system, a new maintenance-related code is determined from the defined library of maintenance-related codes for the item of modular industrial equipment, from the plurality of features.

In another example, a system includes a network interface, a feature extractor, and an expert system. A network interface receives a maintenance report for an item of modular industrial equipment. The maintenance report includes a maintenance-related code, selected from a defined library of maintenance-related codes, and a free text field describing one of an observation of the item of modular equipment that is inconsistent with a defined specification and an action taken to repair or maintain the item of modular industrial equipment. The feature extractor extracts a plurality of features representing the semantic content of a free-text field. An expert system determines a new maintenance-related code from the defined library of maintenance-related codes for the item of modular industrial equipment, from the plurality of features. The expert system includes a plurality of machine learning models, with each of the machine learning models having an associated feature set that is a proper subset of the plurality of features and a model infrastructure selected from a set of model infrastructures.

In accordance with another aspect of the present invention, a system includes a network interface, a feature extractor, and an expert system. A network interface receives a maintenance report for an aircraft. The maintenance report includes a maintenance-related code and a free text field describing either or both of an observation of the item of modular equipment that is inconsistent with a defined specification and an action taken to repair or maintain the item of modular industrial equipment. The feature extractor extracts a plurality of features representing the semantic content of a free-text field, with at least a portion of the plurality of features being extracted via a document embedding approach. An expert system determines a new maintenance-related code for the maintenance report from the plurality of features. The expert system includes a first machine learning model and a second machine learning model. The first machine learning model uses a first proper subset of the plurality of features to determine if the maintenance-related code associated with the maintenance report should be assigned as a first code. The second machine learning model uses a second proper subset of the plurality of features to determine if the maintenance-related code associated with the maintenance report should be assigned as a second code. The first proper subset of the plurality of features is different from the second proper of the plurality of features.

### BRIEF DESCRIPTION OF THE DRAWINGS

FIG. 1 illustrates a system for evaluating maintenance reports;

FIG. 2 illustrates one example of a maintenance report;

FIG. 3 illustrates one implementation of a system for evaluating maintenance reports for military aircraft;

FIG. 4 illustrates one example of a method for evaluating maintenance reports;

FIG. 5 illustrates another example of a method for evaluating maintenance reports; and

FIG. 6 is a schematic block diagram illustrating an exemplary system of hardware components for implementing the systems and methods described herein.

### DETAILED DESCRIPTION

As used herein, “modular industrial equipment,” is equipment that is intended for industrial or commercial use and subjected to regular maintenance and comprised of a number of a plurality of modules or parts that can be individually replaced or repaired. Modular industrial equipment is intended to include at least commercial and military vehicles, such as aircraft, heavy equipment, and machines used for industrial production.

As used herein, a “maintenance report” is a standardized form used to report either or both of an issue with an item of modular industrial equipment that requires maintenance or an action taken to maintain an item of modular industrial equipment. A maintenance report includes both a class to which the issue or action belongs as well as a free text portion describing the action and the maintenance incident.

As used herein, a “maintenance-related code” is a code in a maintenance report that represents a type of support or maintenance of an item of modular equipment. In general, a maintenance-related code represents a condition of an item of modular equipment that is inconsistent with a defined specification, for example, obsolescence of a component, malfunction of a component or system, or function of the item of modular equipment outside of parameters defined in the specification or an action taken to repair or maintain the item of modular equipment.

An “infrastructure” of a supervised machine learning model, as used herein, is an underlying pattern recognition algorithm that is trained on labeled data to produce a machine learning model, as well as any kernels or hyperparameters defining the model. Examples of machine learning model infrastructure include a linear support vector machine, an artificial neural network with a defined number of hidden layers and nodes in each layer, a random forest classifier in which a number of trees and a depth of each tree is defined, a logistic regression model with a defined regularization parameter, and a naïve Bayes model with a selected constant for Laplace smoothing.

The new era of big data has harbored rapid growth and advancements in data science, paving the path for organizations to have the opportunity to make better data driven decisions. A study done by Deloitte has shown that predictive maintenance programs improve equipment uptime and availability by ten to twenty percent and reduce overall maintenance costs by five to ten percent. (Deloitte Analytics Institute, 2017). A major challenge for predictive maintenance is the quality of the data, with an increased risk for systems with manually entered data. Examples of manually entered data which are essential to predictive maintenance are codes representing malfunction of an item of equipment, codes representing obsolescence of one or more parts associated with the equipment, and codes representing actions taken to maintain the equipment. To ensure accurate data, each code for every maintenance action must be verified, based off of descriptions and other attributes. Examples of maintenance reports and associated codes can be found in summaries of The Navy Aviation Maintenance Program at NavyBMR, particularly, Chapter 10, available at http://www.navybmr.com/study%20material/COMNAVAIRFORINST%204790.2C/Chapter%2010.pdf, and Chapter 15, available at http://www.navybmr.com/study%20material/COMNAVAIRFORINST%204790.2B/Chapter%2015.pdf. Each of these documents is hereby incorporated by reference in their entirety.

Verifying the classification of maintenance reports is time intensive and expensive to perform manually due to the volume of reports which is challenging for an automated system. In general, a maintenance report contains very little free text for a classifier to utilize, which creates a challenge for the common techniques for indexing documents. Furthermore, some maintenance issues are significantly more common than others. As a result, the training data for each class is highly unbalanced, with less common issues and repairs having only sparse data sets for training.

The systems and methods described herein provide a multi-faceted strategy to automate domain specific, multi-class text classification. This strategy includes various preprocessing approaches, feature extraction approaches, and supervised learning methods applied in a one-versus-all classification. The preprocessing methodologies are specifically created for domain-specific classification. The feature extraction methodology provides multiple approaches, with each model in the one-versus-all classification that can utilize a selected one of a plurality of available preprocessing techniques as well as one of the feature extraction techniques. This framework drastically improves the efficiency of classifying domain specific text with the use of a computer. The methods applied provide high accuracy without requiring significant computing power, and provides high accuracies even for imbalanced datasets as well as high sparsity of data and low sparsity of data. Accordingly, the algorithm is specifically tailored to increase accuracies for domain specific text classification through its unique preprocessing methodologies and feature extraction methodologies.

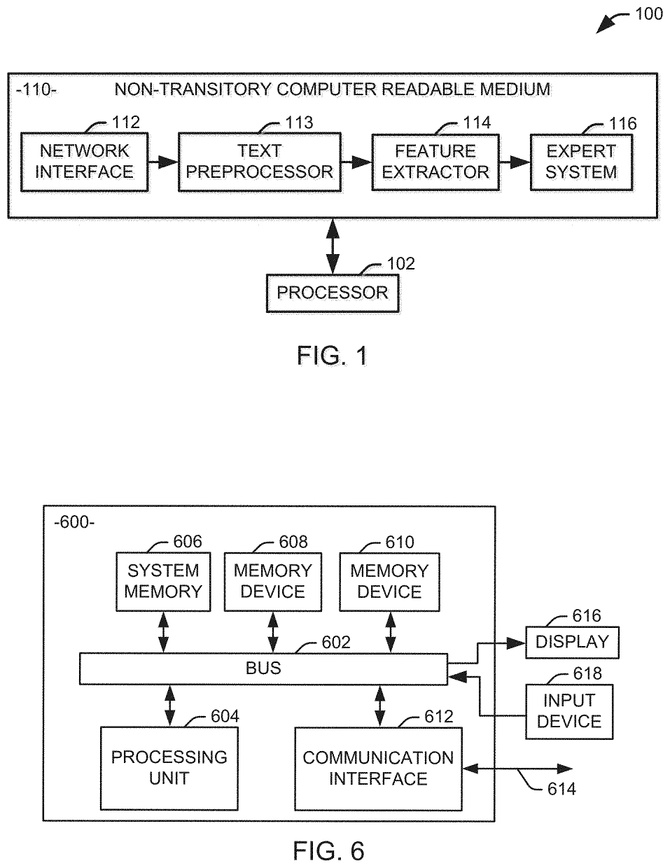

FIG. 1 illustrates a system 100 for evaluating maintenance reports. Specifically, the system 100 can categorize each maintenance report into a category representing either a maintenance issue for an item of modular industrial equipment or an action taken to maintain the item of equipment. The system 100 includes a processor 102 and a non-transitory computer readable medium 110 storing computer readable instructions, executed by the processor 102. The executable instructions stored on the non-transitory computer readable medium 110 include a network interface 112 via which the system 100 communicates with other systems (not shown) via a network connection, for example, an Internet connection and/or a connection to an internal network. In the illustrated example, the other systems can include a database system that stores maintenance reports and other pertinent information for one or more items of modular industrial equipment. It will be appreciated that the system 100 can be implemented as a virtual or cloud server, in which case the processor 102 and the non-transitory computer readable medium 110 may be shared by other applications.

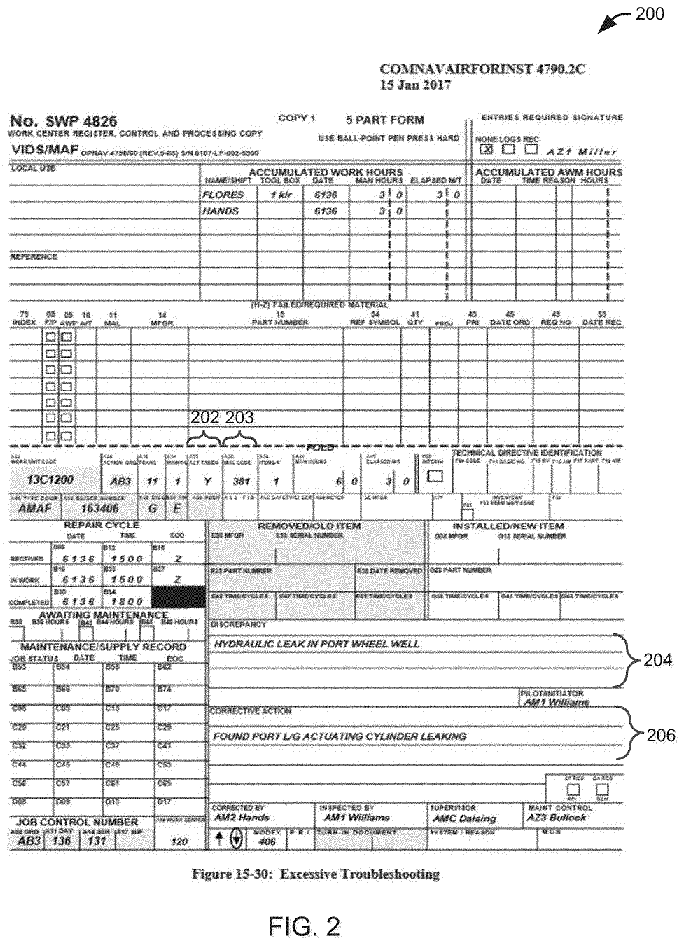

Maintenance reports can be extracted from the database (not shown) or a user terminal (not shown) via the network interface 112 and provided to a text preprocessor 113. One example of a maintenance report 200 is shown as FIG. 2. Along with information about the specific equipment serviced, the time taken, and the identities of the personnel performing the maintenance, the report 200 includes an action code 202 that represents a category of action taken to maintain the equipment, and a malfunction code 203 that identifies a category into which the issue with the equipment addressed by the action falls. It will be appreciated that the malfunction codes and action codes can be maintenance-related codes specific to a given type of modular industrial equipment. The report 200 further includes a first free text description 204 that describes a “discrepancy,” that is, the symptoms of the malfunction observed in the equipment. A second free text description 206 describes a corrective action taken to address the malfunction.

The text preprocessor 113 can apply various techniques to prepare text for analysis by an automated system, including, but not limited to, combining multiple free text fields in the report, removing case from the individual letters, removing white space and punctuation between words, separating the text into tokens, such as words or phrases, removing stop words, that is, common words with little value for distinguishing among categories, such as articles, common verbs (e.g., various conjugations of “to be” or “to do”, and common prepositions (e.g., “for”, “to”), and stemming the words to a base of the word lacking common prefixes and suffixes.

A feature extractor 114 receives and extracts a plurality of features for use at an expert system 116. The feature extractor 114 extracts the features from one or more free text regions on the maintenance report. To this end, the feature extractor 114 can compute the frequencies of various terms within the extracted text. In one implementation, a straight count of each token can be used. In another example, the tokens are normalized according to the total number of relevant tokens found in a given document, referred to herein as “normalized count occurrence.” In a third implementation, the bag-of-words features can be weighted using the token frequency according to term frequency-inverse document frequency (tfidf), such that terms that occur relatively infrequently across reports are accorded more weight per occurrence than more common terms. In practice, a given implementation of the system 100 can use multiple of these approaches as options for each classification model.

The feature extractor 114 can then utilize the computed frequencies as part of one or more natural language processing algorithms for extracting data from unstructured text. It will be appreciated that, in some implementations, the category code assigned by the individual completing the maintenance report can be given some degree of weight in the classification task. In other implementations, the category is assigned without regard to the original classification based on the content of the free text. In one example, a bag-of-words approach is utilized. In the bag-of-words approach, each report is represented as a feature vector generated according to the frequency of terms within the report, either via straight count, normalized count frequency, or term frequency-inverse document frequency. In one implementation, the bag-of-words can be implemented using N-gram tokens, such that the dictionary of tokens used in the bag-of-words analysis contains individual words as well as phrases of two or more words.

In another example, a topic modeling approach is utilized, in which latent topics in the maintenance report free text can be identified to provide data for classification. Topic modeling is an unsupervised method to detect these latent topics, which can be used as additional information for classifying events. In one example, the feature extractor 114 can generate a document-word matrix, in which each column represents a maintenance report, each row represents a term of interest, and each element represents the frequency of a given term in a given report. A truncated singular value decomposition (tSVD) analysis can be applied to the document-term matrix to generate a set of singular values representing potential topics, as well as two additional matrices relating the terms and the documents, respectively, to the potential topics. The truncation occurs in keeping only a set of the highest singular values from the set. This approach is referred to as latent semantic analysis, and the topics are referred to as latent topics. Once an appropriate set of latent topics are identified during training of the system 100, the feature extractor 114 can transform each report into a topic representation formed from the latent topics expected to generate the terms observed in the report.

In one example, the feature extractor 114 can utilize latent semantic indexing, which is a generative topic model that discovers topics in textual documents. In latent semantic indexing, a vocabulary of terms is either preselected or generated as part of the indexing process. A matrix is generated representing the frequency of occurrence of each term in the vocabulary of terms within each document, such that each row of the matrix represents a term and each column represents a document. It will be appreciated that the frequencies can be generated as normalized count frequencies or using term frequency-inverse document frequency (tfidf). The matrix is then subjected to a dimensionality reduction technique to project the terms into a lower dimensional latent semantic space. In the illustrated example, the dimensionality reduction technique is a truncated singular value decomposition. Each document is then represented by the projected values in the appropriate column of the reduced matrix.

In another example, a word embedding approach, such as Word2Vec, or a document embedding approach, such as Doc2Vec can be used. In Word2Vec, a neural network with an input layer, in which each node represents a term, is trained on proximate word pairs within a document to provide a classifier that identifies words likely to appear in proximity to one another. The weights for the links between an input node representing a given word and the hidden layer can then be used to characterize the content of the document, including semantic and syntactic relatedness between the words.

Paragraph Vector Distributed Memory (PV-DM) is an extension of the word embedding approach. In PV-DM, context from each paragraph (or appropriate text) is included as an input to the model, and link weights associated with these inputs is generated for each paragraph as part of the training process, representing the specific context of that paragraph. Accordingly, the model is trained to predict words likely to appear in proximity to one another for a given paragraph in the document to produce a paragraph vector, with each column representing the trained context for each paragraph in the document. This can be averaged or concatenated with the word vectors for the document to generate a set of features for the document that captures embedding representations averaged across occurring words and word sequences.

In the illustrated system, the expert system 116 uses the extracted features to classify a novel maintenance report, that is, an event report that was not presented in a training set for the model, into one or more of a plurality of categories. The machine learning model 116 can utilize one or more pattern recognition algorithms, implemented, for example, as classification and regression models, each of which analyze the extracted features or a subset of the extracted features to classify the reports into one of the categories. The selected category can be provided to a user at an associated display (not shown) or stored on the non-transitory computer readable medium 110, for example, in a record associated with the maintenance report.

In one example, each category is represented by an individual machine learning model in a one-vs-all arrangement. In this example, each of a plurality of machine learning models are trained as a binary classifier that distinguishes between a code category associated with the machine learning model and all other classes. In this example, the output of the machine learning model is a categorical or continuous parameter that reflects a likelihood that the maintenance report is properly categorized with the code represented by the machine learning model. An arbitration element can be utilized to provide a coherent result from the plurality of machine learning models, for example, as the class having a highest continuous output or a highest confidence in a categorical output. In one example, the arbitration element can itself be implemented as a classification model that receives the outputs of the plurality of models as features and generates one or more maintenance-related codes for the maintenance report.

The machine learning models can be trained on training data representing the various classes of interest. In one implementation, the machine learning model can use different model architectures, different sets of associated features, and different (or no) preprocessing techniques. The training process of a given model will vary with its implementation, but training generally involves a statistical aggregation of training data into one or more parameters associated with the output classes. Any of a variety of techniques can be utilized for the models, including support vector machines (SVMs), regression models, self-organized maps, fuzzy logic systems, data fusion processes, boosting and bagging methods, rule-based systems, or artificial neural networks (ANNs).

For example, an SVM classifier can utilize a plurality of functions, referred to as hyperplanes, to conceptually divide boundaries in the N-dimensional feature space, where each of the N dimensions represents one associated feature of the feature vector. The boundaries define a range of feature values associated with each class. Accordingly, an output class and an associated confidence value can be determined for a given input feature vector according to its position in feature space relative to the boundaries. An SVM classifier utilizes a user-specified kernel function to organize training data within a defined feature space. In the most basic implementation, the kernel function can be a radial basis function, although the systems and methods described herein can utilize any of a number of linear or non-linear kernel functions.

An ANN classifier comprises a plurality of nodes having a plurality of interconnections. The values from the feature vector are provided to a plurality of input nodes. The input nodes each provide these input values to layers of one or more intermediate nodes. A given intermediate node receives one or more output values from previous nodes. The received values are weighted according to a series of weights established during the training of the classifier. An intermediate node translates its received values into a single output according to a transfer function at the node. For example, the intermediate node can sum the received values and subject the sum to a binary step function. A final layer of nodes provides the confidence values for the output classes of the ANN, with each node having an associated value representing a confidence for one of the associated output classes of the classifier.

A regression model applies a set of weights to various functions of the extracted features, most commonly linear functions, to provide a continuous result. In general, regression features can be categorical, represented, for example, as zero or one, or continuous. In a logistic regression, the output of the model represents the log odds that the source of the extracted features is a member of a given class. In a binary classification task, these log odds can be used directly as a confidence value for class membership or converted via the logistic function to a probability of class membership given the extracted features.

A rule-based classifier applies a set of logical rules to the extracted features to select an output class. Generally, the rules are applied in order, with the logical result at each step influencing the analysis at later steps. The specific rules and their sequence can be determined from any or all of training data, analogical reasoning from previous cases, or existing domain knowledge. One example of a rule-based classifier is a decision tree algorithm, in which the values of features in a feature set are compared to corresponding threshold in a hierarchical tree structure to select a class for the feature vector. A random forest classifier is a modification of the decision tree algorithm using a bootstrap aggregating, or “bagging” approach. In this approach, multiple decision trees are trained on random samples of the training set, and an average (e.g., mean, median, or mode) result across the plurality of decision trees is returned. For a classification task, the result from each tree would be categorical, and thus a modal outcome can be used.

In one implementation, the code for the maintenance report can be assigned de novo, with no reference to the original code. In another implementation, the code assigned in the maintenance report can be used as part of the analysis. In one example, the code can be changed only if a known accuracy for manually entered codes for that class is less than a confidence of the expert system 116. Alternatively, the code from the maintenance form can be used to assign an a priori probability in a Bayesian analysis, for example, from the known accuracy for the manually entered code, and the probability that the maintenance report is properly coded can be updated according to the results of the expert system 116.

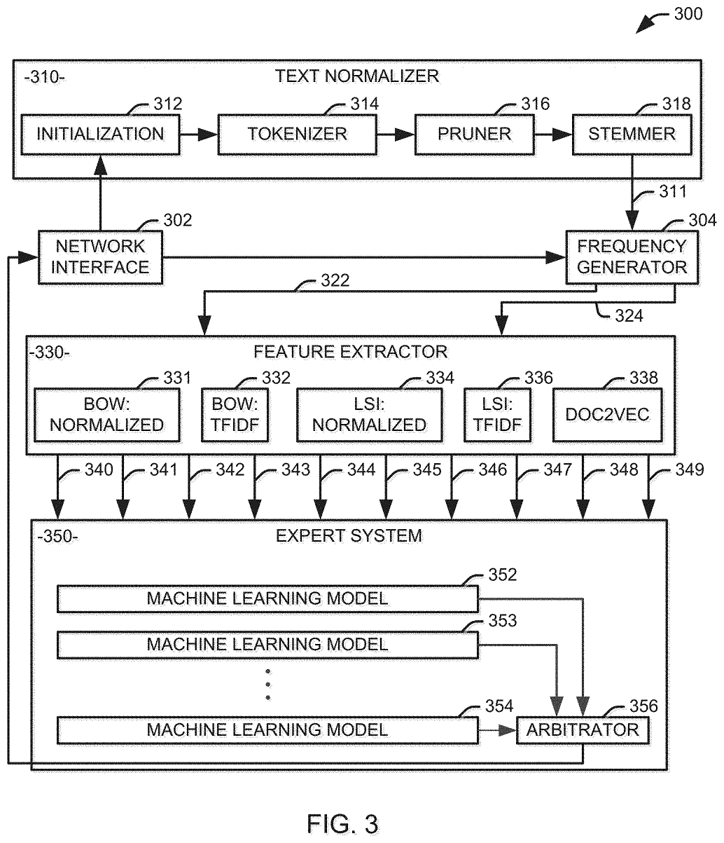

FIG. 3 illustrates one implementation of a system 300 for evaluating maintenance reports for military aircraft. In this example, the system 300 determines a maintenance-related code for each maintenance report, but in practice, the system could be employed to determine multiple maintenance-related codes for each report. In the illustrated system 300, each functional block 302, 304, 310, 330, and 350 is implemented as software instructions stored in a tangible memory and executed by an associated processor. A network interface 302 receives a maintenance report 303 from an associated database or client system on the network. The maintenance report 303 is provided to each of a frequency generator 304 and a text normalizer 310. It will be appreciated that, in some implementations, the network interface 302 can retrieve only the free text portions of a given maintenance report as opposed to the entire report.

The text normalizer 310 prepares a preprocessed text 311 from the maintenance report. The text normalizer 310 includes an initialization component 312 that joins multiple text fields from the maintenance report, where present, into a single block of text, shifts all letters in the text to lower case, and removes all white space and punctuation from the text. A tokenizer 314 splits the text into tokens, which can be words or phrases (i.e., n-grams). The tokenizer 314 can use a general dictionary of words and phrases to identify individual tokens. A pruner 316 removes common words with little relevant information content, such as articles, prepositions, pronouns, and similar words. While individual stop words can vary with the domain in which the system 300 is operating, an example of a list of English stop words can be found at http://xpo6.com/list-of-english-stop-words/, which is hereby incorporated by reference. A stemmer 318 reduces each word down to a base or root of the word. For example, the word “argument” could be reduced to the root “argu”, such that “argued”, “argues”, “argument”, “arguer”, “arguing,” and “argumentative” all reduce to the common root “argu” and are counted as repeated instances of the same root. In one example, the stemmer 318 uses a Porter stemming algorithm.

Each of the raw maintenance report 303 or extracted free text and the preprocessed text 311 are provided to the frequency generator 304. The frequency generator 304 determines a frequency of the each of a plurality of words in an associated dictionary in each text 303 and 311. It will be appreciated that the frequency for text can include a total number of words and a raw word count for each word. Alternatively, a normalized frequency can be provided for each dictionary word. Each of a first set of dictionary word frequencies 322, representing the raw text, and a second set of dictionary word frequencies 324, representing the preprocessed text, can be provided to a feature extractor 330.

The feature extractor 330 produces multiple sets of features from each of the first and second sets of dictionary word frequencies 322 and 324. The feature extractor 330 applies five different feature extraction techniques 331, 332, 334, 336, and 338 to each received set of dictionary word frequencies 322 and 324 to provide ten separate sets of features 340-349. Specifically, the feature extractor 330 includes two bag-of-words (BOW) extractors 331 and 332, with a first 331 using a normalized count frequency and a second 332 using a term frequency-inverse document frequency, two latent semantic indexing (LSI) extractors 334 and 336, with a first 334 using a normalized count frequency and a second 336 using a term frequency-inverse document frequency, and an document embedding algorithm, more specifically, Doc2Vec.

The outputs of the feature extractor 330 include a first set of features 340 derived using the document embedding approach on the preprocessed text, a second set of features 341 derived using bag of words with normalized count frequency on the preprocessed text, a third set of features 342 derived using bag of words with term frequency-inverse document frequency on the preprocessed text, a fourth set of features 343 derived using latent semantic indexing with normalized count frequency on the preprocessed text, a fifth set of features 344 derived using latent semantic indexing with term frequency-inverse document frequency on the preprocessed text, a sixth set of features 345 derived using the document embedding approach directly on the free-text field, a seventh set of features 346 derived using bag of words with normalized count frequency directly on the free-text field, an eighth set of features 347 derived using bag of words with term frequency-inverse document frequency directly on the free-text field, a ninth set of features 348 derived using latent semantic indexing with normalized count frequency directly on the free-text field, and a tenth set of features 349 derived using latent semantic indexing with term frequency-inverse document frequency directly on the free-text field. Each output 340-349 is provided to an expert system 350.

The expert system 350 comprises a plurality of machine learning models 352-354 and an arbitrator 356. Each of the machine learning models 352-354 represent a specific maintenance-related code and provide an output representing a likelihood that the maintenance report should be assigned the associated maintenance-related code from a set of received features. Each machine learning model 352-354 receives less than all of the ten sets of features 340-349, and in one implementation, each machine learning model receives only one of the ten sets of features. The machine learning models 352-354 include at least support vector machines, logistic regression models, random forest classifiers, and naïve Bayes classifiers, each trained on their respective sets of features using manually verified maintenance reports. It will be appreciated that the hyperparameters associated with each model 352-354 can be different even among models using a same classification algorithm (e.g., two logistic regression models). In practice, the architecture and feature set used for each machine learning model 352-354 can be determined by training a plurality of models for each code and evaluating the accuracy of each combination of architecture and feature set.

The output from each of the plurality of machine learning models 352-354 is provided to an arbitrator 356 that selects a maintenance-related code for the maintenance report according to the outputs of the machine learning models. In one example, the arbitrator 356 can include one or more functions or look-up tables to translate an output of each machine learning model 352-354 into a standard value, for example, a value representing a likelihood that the maintenance-related code represented by the model should be assigned to the maintenance report. The arbitrator 356 can select the code associated with the machine learning model 352-354 providing a maximum or minimum standard value as the maintenance-related code that should be assigned to the maintenance report. A database storing maintenance reports can then be updated with the selected maintenance-related code via the network interface 302.

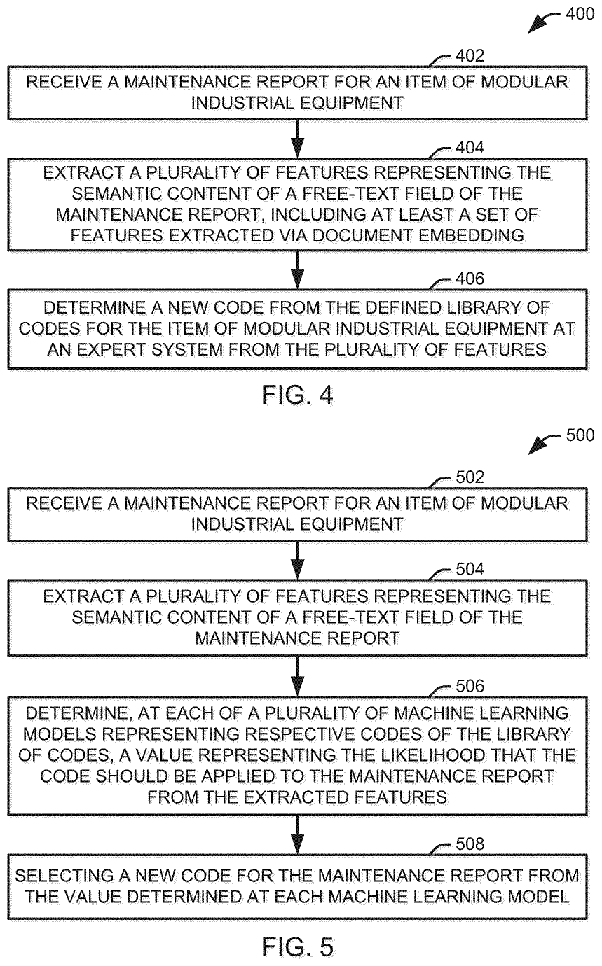

In view of the foregoing structural and functional features described above, a method in accordance with various aspects of the present invention will be better appreciated with reference to FIGS. 4 and 5. While, for purposes of simplicity of explanation, the methods of FIGS. 4 and 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a method in accordance with an aspect the present invention.

FIG. 4 illustrates one example of a method 400 for evaluating maintenance reports. Specifically, the method 400 selects at least one maintenance-related code for a maintenance report from a defined library of maintenance-related codes. In one example, the item of modular industrial equipment is an aircraft and the defined library of codes is a set of maintenance-related codes associated with the aircraft. At 402, a maintenance report is received for an item of modular industrial equipment. The maintenance report includes a code, selected from a defined library of codes. Each code in the library of codes represents one of an observation of the item of modular equipment that is inconsistent with a defined specification and an action taken to repair or maintain the item of modular equipment. The maintenance report further includes a free text field describing the observation of the item of modular equipment that is inconsistent with a defined specification or the action taken to repair or maintain the item of modular industrial equipment. In some examples, a preprocessing technique is applied to prepare a preprocessed text from the free-text field.

At 404, a plurality of features representing the semantic content of a free-text field is extracted, with at least a portion of the plurality of features being extracted via a document embedding approach. In one implementation, the plurality of features includes a first set of features derived using the document embedding approach, a second set of features derived using bag of words with normalized count frequency, a third set of features derived using bag of words with term frequency-inverse document frequency, a fourth set of features derived using latent semantic indexing with normalized count frequency, and a fifth set of features derived using latent semantic indexing with term frequency-inverse document frequency. Where preprocessing is used, a first subset of the plurality of features can be extracted from the preprocessed text and a second subset of the plurality of features can be extracted directly from the free-text field.

At 406, a new code from the defined library of codes for the item of modular industrial equipment is determined at an expert system from the plurality of features. In one implementation, the expert system includes a plurality of machine learning models, with each of the machine learning models representing a code from the library of codes. In this implementation, each of the machine learning models has an associated feature set that is a proper subset of the plurality of features and a model infrastructure selected from a set of model infrastructures. The set of model infrastructures can include, for example, at least a first infrastructure utilizing a linear support vector machine, a second infrastructure utilizing a naïve Bayes classifier, a third infrastructure utilizing a random forest classifier, and a fourth infrastructure utilizing a logistic regression model. Each machine learning model can use less than all of the available features for its associated feature set, such that the machine learning model representing each of the library of codes can be trained on different features and use a different infrastructure.

FIG. 5 illustrates another example of a method 500 for evaluating maintenance reports. Specifically, the method 500 selects a maintenance-related code for a maintenance report from a defined library of maintenance-related codes. In one example, the item of modular industrial equipment is an aircraft and the defined library of codes is one of a set of maintenance-related codes associated with the aircraft. At 502, a maintenance report is received for an item of modular industrial equipment. The maintenance report includes a code, selected from a defined library of codes. Each code in the library of codes represents one of an observation of the item of modular equipment that is inconsistent with a defined specification and an action taken to repair or maintain the item of modular equipment. The maintenance report further includes a free text field describing the observation of the item of modular equipment that is inconsistent with a defined specification or the action taken to repair or maintain the item of modular industrial equipment. In some examples, a preprocessing technique is applied to prepare a preprocessed text from the free-text field.

At 504, a plurality of features representing the semantic content of a free-text field is extracted. At 506, a value is determined at each of a plurality of machine learning models from the extracted plurality of features. Each of the machine learning models represents one of the defined library of codes, and the generated value represents the likelihood that the code associated with the machine learning model should be assigned to the maintenance report. Each of the machine learning models has an associated feature set that is a proper subset of the plurality of features and a model infrastructure selected from a set of model infrastructures, and each model

The set of model infrastructures can include, for example, at least a first infrastructure utilizing a linear support vector machine, a second infrastructure utilizing a naïve Bayes classifier, a third infrastructure utilizing a random forest classifier, and a fourth infrastructure utilizing a logistic regression model. Each machine learning model can use less than all of the available features for its associated feature set, such that the machine learning model representing each of the library of codes can be trained on different features and use a different infrastructure. Accordingly, at least one machine learning model will utilize a different architecture and feature set than another machine learning model, with the architecture and feature set for each machine learning model selected to provide a maximum accuracy on a set of test data for its associated code.

In one implementation, the plurality of features includes a first set of features derived using the document embedding approach, a second set of features derived using bag of words with normalized count frequency, a third set of features derived using bag of words with term frequency-inverse document frequency, a fourth set of features derived using latent semantic indexing with normalized count frequency, and a fifth set of features derived using latent semantic indexing with term frequency-inverse document frequency. In one example, each of the machine learning models will use a feature set that excludes at least one of these sets of features, and in another example, each machine model will use one and only one of these feature sets. At 508, a new maintenance-related code for the maintenance report is selected according to the value produced at each machine learning model. In practice, the maintenance-related code associated with the machine learning model producing a value representing a maximum likelihood that the maintenance report should be assigned its associated code will be selected.

FIG. 6 is a schematic block diagram illustrating an exemplary system 600 of hardware components capable of implementing examples of the systems and methods disclosed herein. The system 600 can include various systems and subsystems. The system 600 can be a personal computer, a laptop computer, a workstation, a computer system, an appliance, an application-specific integrated circuit (ASIC), a server, a server BladeCenter, a server farm, etc.

The system 600 can include a system bus 602, a processing unit 604, a system memory 606, memory devices 608 and 610, a communication interface 612 (e.g., a network interface), a communication link 614, a display 616 (e.g., a video screen), and an input device 618 (e.g., a keyboard, touch screen, and/or a mouse). The system bus 602 can be in communication with the processing unit 604 and the system memory 606. The additional memory devices 608 and 610, such as a hard disk drive, server, standalone database, or other non-volatile memory, can also be in communication with the system bus 602. The system bus 602 interconnects the processing unit 604, the memory devices 606-610, the communication interface 612, the display 616, and the input device 618. In some examples, the system bus 602 also interconnects an additional port (not shown), such as a universal serial bus (USB) port.

The processing unit 604 can be a computing device and can include an application-specific integrated circuit (ASIC). The processing unit 604 executes a set of instructions to implement the operations of examples disclosed herein. The processing unit can include a processing core.

The additional memory devices 606, 608, and 610 can store data, programs, instructions, database queries in text or compiled form, and any other information that may be needed to operate a computer. The memories 606, 608 and 610 can be implemented as computer-readable media (integrated or removable), such as a memory card, disk drive, compact disk (CD), or server accessible over a network. In certain examples, the memories 606, 608 and 610 can comprise text, images, video, and/or audio, portions of which can be available in formats comprehensible to human beings.

Additionally or alternatively, the system 600 can access an external data source or query source through the communication interface 612, which can communicate with the system bus 602 and the communication link 614.

In operation, the system 600 can be used to implement one or more parts of a system for evaluating maintenance reports in accordance with the present invention, in particular, the feature extractor 114 and the expert system 116. Computer executable logic for implementing the system for evaluating maintenance reports resides on one or more of the system memory 606, and the memory devices 608 and 610 in accordance with certain examples. The processing unit 604 executes one or more computer executable instructions originating from the system memory 606 and the memory devices 608 and 610. The term “computer readable medium” as used herein refers to a medium that participates in providing instructions to the processing unit 604 for execution. This medium may be distributed across multiple discrete assemblies all operatively connected to a common processor or set of related processors.

Specific details are given in the above description to provide a thorough understanding of the embodiments. However, it is understood that the embodiments can be practiced without these specific details. For example, physical components can be shown in block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps, and means described above can be done in various ways. For example, these techniques, blocks, steps, and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method comprising:
receiving a maintenance report for an item of modular industrial equipment, the maintenance report comprising a maintenance-related code, selected from a defined library of maintenance-related codes, and a free text field describing one of an observation of the item of modular equipment that is inconsistent with a defined specification and an action taken to repair or maintain the item of modular industrial equipment;
extracting a plurality of features representing the semantic content of a free-text field, at least a portion of the plurality of features being extracted via a document embedding approach; and
determining, at an expert system, a new maintenance-related code from the defined library of maintenance-related codes for the item of modular industrial equipment, from the plurality of features.

2. The method of claim 1, wherein the expert system comprises a plurality of machine learning models, each of the machine learning models having an associated feature set that is a proper subset of the plurality of features and a model infrastructure selected from a set of model infrastructures.

3. The method of claim 2, wherein the set of model infrastructures includes at least a first infrastructure utilizing a linear support vector machine, a second infrastructure utilizing a naïve Bayes classifier, a third infrastructure utilizing a random forest classifier, and a fourth infrastructure utilizing a logistic regression model.

4. The method of claim 2, wherein the plurality of features includes a first set of features derived using the document embedding approach, a second set of features derived using bag of words with normalized count frequency, a third set of features derived using bag of words with term frequency-inverse document frequency, a fourth set of features derived using latent semantic indexing with normalized count frequency, and a fifth set of features derived using latent semantic indexing with term frequency-inverse document frequency, and the associated feature set for each of the plurality of machine learning models excludes one of the first set of features, the second set of features, the third set of features, the fourth set of features, and the fifth set of features.

5. The method of claim 4, wherein the associated feature set for each of the plurality of machine learning models consists of one of the first set of features, the second set of features, the third set of features, the fourth set of features, and the fifth set of features.

6. The method of claim 1, further applying at least one preprocessing technique to prepare a preprocessed text from the free-text field, wherein a first subset of the plurality of features are extracted from the preprocessed text and a second subset of the plurality of features are extracted directly from the free-text field.

7. The method of claim 1, wherein the item of modular industrial equipment is an aircraft and the defined library of maintenance-related codes is one of a set of maintenance-related codes associated with the aircraft.

8. A system comprising:
a network interface that receives a maintenance report for an item of modular industrial equipment, the maintenance report comprising a maintenance-related code, selected from a defined library of maintenance-related codes, and a free text field describing one of an observation of the item of modular equipment that is inconsistent with a defined specification and an action taken to repair or maintain the item of modular industrial equipment;
a feature extractor that extracts a plurality of features representing the semantic content of a free-text field; and
an expert system that determines a new maintenance-related code from the defined library of maintenance-related codes for the item of modular industrial equipment, from the plurality of features, the expert system comprising a plurality of machine learning models, each of the machine learning models having an associated feature set that is a proper subset of the plurality of features and a model infrastructure selected from a set of model infrastructures.

9. The system of claim 8, wherein at least a portion of the plurality of features are extracted via a document embedding approach.

10. The system of claim 8, further comprising a text preprocessor that applies at least one preprocessing technique to prepare a preprocessed text field from the free-text field, the feature extractor extracting a first set of the plurality of features from the preprocessed text and extracting a second set of the plurality of features directly from the free-text field.

11. The system of claim 10, wherein a first proper subset of the plurality of features associated with a first machine learning model of the plurality of machine learning models includes only features from the first set of the plurality of features, and a second proper subset of the plurality of features associated with a second machine learning model of the plurality of machine learning models includes only features from the second set of the plurality of features.

12. The system of claim 8, wherein the set of model infrastructures includes at least a first infrastructure utilizing a linear support vector machine, a second infrastructure utilizing a naïve Bayes classifier, a third infrastructure utilizing a random forest classifier, and a fourth infrastructure utilizing a logistic regression model.

13. The system of claim 8, wherein a first machine learning model has a model infrastructure utilizing a first pattern recognition algorithm with a first set of hyperparameters and a second machine learning model has a model infrastructure utilizing the first pattern recognition algorithm with a second set of hyperparameters.

14. The system of claim 8, wherein the plurality of features includes a first set of features derived using the document embedding approach, a second set of features derived using bag of words with normalized count frequency, a third set of features derived using bag of words with term frequency-inverse document frequency, a fourth set of features derived using latent semantic indexing with normalized count frequency, and a fifth set of features derived using latent semantic indexing with term frequency-inverse document frequency, and the associated feature set for each of the plurality of machine learning models excludes one of the first set of features, the second set of features, the third set of features, the fourth set of features, and the fifth set of features.

15. The system of claim 8, further comprising a text preprocessor that applies at least one preprocessing technique to prepare a preprocessed text field from the free-text field, the feature extractor extracting a first set of the plurality of features from the preprocessed text and extracting a second set of the plurality of features directly from the free-text field, such that the plurality of features includes a first set of features derived using the document embedding approach on the preprocessed text, a second set of features derived using bag of words with normalized count frequency on the preprocessed text, a third set of features derived using bag of words with term frequency-inverse document frequency on the preprocessed text, a fourth set of features derived using latent semantic indexing with normalized count frequency on the preprocessed text, a fifth set of features derived using latent semantic indexing with term frequency-inverse document frequency on the preprocessed text, a sixth set of features derived using the document embedding approach directly on the free-text field, a seventh set of features derived using bag of words with normalized count frequency directly on the free-text field, an eighth set of features derived using bag of words with term frequency-inverse document frequency directly on the free-text field, a ninth set of features derived using latent semantic indexing with normalized count frequency directly on the free-text field, and a tenth set of features derived using latent semantic indexing with term frequency-inverse document frequency directly on the free-text field, the associated feature set for each of the plurality of machine learning models excludes one of the first set of features, the second set of features, the third set of features, the fourth set of features, the fifth set of features, the sixth set of features, the seventh set of features, the eighth set of features, the ninth set of features, and the tenth set of features.

16. The system of claim 15, wherein the associated feature set for each of the plurality of machine learning models consists of one of the first set of features, the second set of features, the third set of features, the fourth set of features, the fifth set of features, the sixth set of features, the seventh set of features, the eighth set of features, the ninth set of features, and the tenth set of features.

17. A system comprising:
a network interface that receives a maintenance report for an aircraft, the maintenance report comprising a maintenance-related code and a free text field describing one of an observation of the item of modular equipment that is inconsistent with a defined specification and an action taken to repair or maintain the item of modular industrial equipment;
a feature extractor that extracts a plurality of features representing the semantic content of a free-text field, at least a portion of the plurality of features being extracted via a document embedding approach; and
an expert system that determines f a new maintenance-related code for the maintenance report from the plurality of features, the expert system comprising:
a first machine learning model, that uses a first proper subset of the plurality of features to determine if the maintenance-related code associated with the maintenance report should be assigned as a first code represented by the first machine learning model; and
a second machine learning model, that uses a second proper subset of the plurality of features to determine if the maintenance-related code associated with the maintenance report should be assigned as a second code represented by the second machine learning model, wherein the first proper subset of the plurality of features is different from the second proper of the plurality of features.

18. The system of claim 17, wherein the first machine learning model utilizing one of a linear support vector machine, a naïve Bayes classifier, a random forest classifier, and a logistic regression model and the second machine learning model utilizes an other of the linear support vector machine, the naïve Bayes classifier, the random forest classifier, and the logistic regression model.

19. The system of claim 17, wherein the first proper subset of the plurality of features includes only features derived using the document embedding approach and the second proper subset of the plurality of features includes only features derived using latent semantic indexing.

20. The system of claim 17, further comprising a text preprocessor that applies at least one preprocessing technique to prepare a preprocessed text field from the free-text field, the feature extractor preparing the first proper subset of the plurality of features using the free-text field and preparing the second proper subset of features from the preprocessed text field.
